(19) United States
(12) Patent Application Publication
(10) Pub. No.: US 2025/0033580 A1
(43) Pub. Date: Jan. 30, 2025

(54) ROUTING STRUCTURE

(71) Applicant: YAZAKI CORPORATION, Tokyo (JP)

(72) Inventors: Mitsunobu Kato, Makinohara-shi (JP); Tatsuya Otsuka, Makinohara-shi (JP); Kazuhiro Tsuchida, Makinohara-shi (JP); Shoya Sugiyama, Makinohara-shi (JP)

(21) Appl. No.: 18/755,598

(22) Filed: Jun. 26, 2024

(30) Foreign Application Priority Data
Jul. 24, 2023 (JP) 2023-119662

(51) Int. Cl. B60R 16/02; H02G 3/04

(52) U.S. Cl. CPC B60R 16/0215; H02G 3/0456

(57) ABSTRACT

A routing structure includes a protector in which an electric wire connecting a vehicle body and a sliding member is routed in a routing path and a rotary member arranged in the routing path, having a cylindrical portion through which the electric wire is inserted, and rotatably supported by the protector. The routing path has a first opening through which the electric wire is drawn out toward the vehicle body. The rotary member is pivotally rotated between a first rotational position and a second rotational position. The first rotational position is a rotational position in which the cylindrical portion is directed toward the sliding member at a first position in a sliding direction. The second rotational position is a rotational position in which the cylindrical portion is directed toward the sliding member at a second position.

### CROSS-REFERENCE TO RELATED APPLICATION(S)

The present application claims priority to and incorporates by reference the entire contents of Japanese Patent Application No. 2023-119662 filed in Japan on Jul. 24, 2023.

### BACKGROUND OF THE INVENTION

### 1. Field of the Invention

The present invention relates to a routing structure.

### 2. Description of the Related Art

Conventionally, power supply devices equipped with a rotary member have been used. Japanese Patent Application Laid-open No. 2015-077053 A describes a power supply device provided with a supporting member, a pivoting member, and a coiled spring. Specifically, in this configuration, the supporting member is fixed to a slide structure or a fixing structure, the pivoting member is pivotally supported by the supporting member and has a wire harness inserted through the pivoting member, and the coiled spring biases the pivoting member in a predetermined pivoting direction.

In a routing structure having a rotary member, excessive bending of an electric wire due to the rotation of the rotary member may adversely affect the durability of the electric wire. It is desirable to be able to reduce the degree of curvature of the electric wire induced by the rotation of the rotary member.

### SUMMARY OF THE INVENTION

The present invention is intended to provide a routing structure that allows the reduction of the degree of curvature of an electric wire induced by the rotation of a rotary member.

In order to achieve the above mentioned object, a routing structure according to one aspect of the present invention includes a protector arranged on either a vehicle body of a vehicle or a sliding member, and having a routing path in which an electric wire used to connect the vehicle body and the sliding member is routed; and a rotary member arranged in the routing path, having a cylindrical portion through which the electric wire is inserted, and rotatably supported by the protector, wherein the routing path has a first opening through which the electric wire is drawn out toward one of the vehicle body and the sliding member, and a second opening through which the electric wire is drawn out toward a counterpart as the other of the vehicle body and the sliding member, the rotary member is pivotally rotated between a first rotational position and a second rotational position, the first rotational position is a rotational position in which the cylindrical portion is directed toward the counterpart in a case where the sliding member is at a first position in a sliding direction, the second rotational position is a rotational position in which the cylindrical portion is directed toward the counterpart in a case where the sliding member is at a second position in the sliding direction, the electric wire is curved between the first opening and the rotary member in a case where the rotary member is at the second rotational position, and the rotary member is pivotally rotated about a shaft center of a rotating shaft, and the shaft center is located on a side of the first opening with respect to a central shaft line of the cylindrical portion in the case where the rotary member is at the second rotational position.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a plan view of a routing structure according to an embodiment;

FIG. 2 is an exploded perspective view of a protector according to an embodiment;

FIG. 3 is a rear view of an upper cover according to an embodiment;

FIG. 4 is an exploded perspective view of a rotary member according to an embodiment;

FIG. 5 is a side view of a first member according to an embodiment;

FIG. 6 is a plan view of a routing structure according to an embodiment;

FIG. 7 is a plan view of a routing structure according to an embodiment;

FIG. 8 is a plan view of a rotary member according to an embodiment;

FIG. 9 is a diagram illustrating a routing route of an electric wire;

FIG. 10 is a diagram illustrating a rotary member according to a comparative example;

FIG. 11 is a plan view of a routing structure according to an embodiment;

FIG. 12 is a diagram illustrating a routing route of an embodiment;

FIG. 13 is a diagram illustrated to describe a shaft center of an embodiment;

FIG. 14 is a diagram illustrating a shaft center arranged in a protrusion; and

FIG. 15 is a plan view illustrating another example of the routing structure according to an embodiment.

### DETAILED DESCRIPTION OF THE PREFERRED EMBODIMENTS

The description is now given a routing structure according to embodiments of the present invention in detail with reference to the drawings. Moreover, the present invention is not limited to these embodiments.

Additionally, the components in the embodiments described below may include those readily conceivable by those skilled in the art or substantially identical ones.

### Embodiment

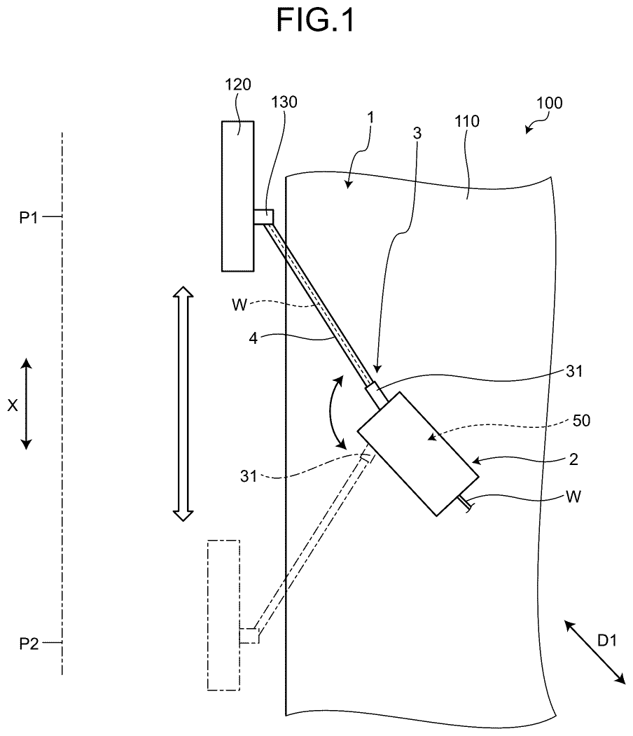

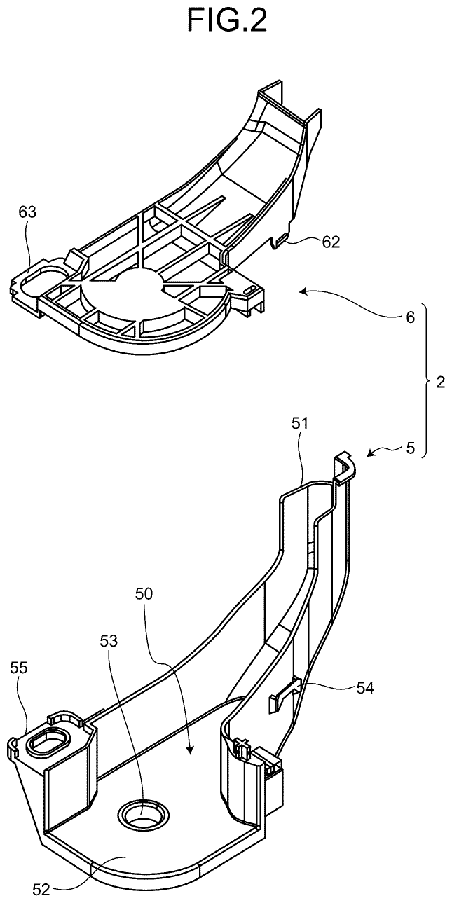

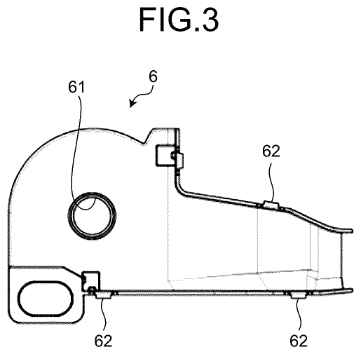

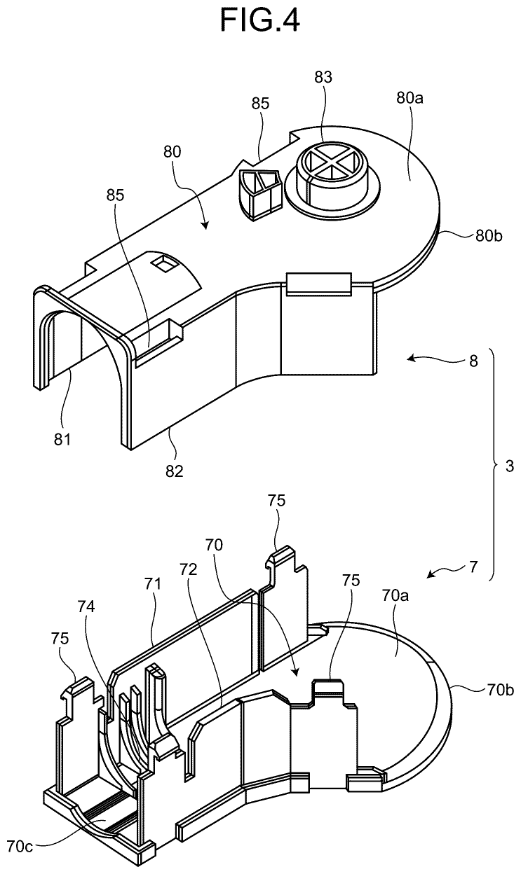

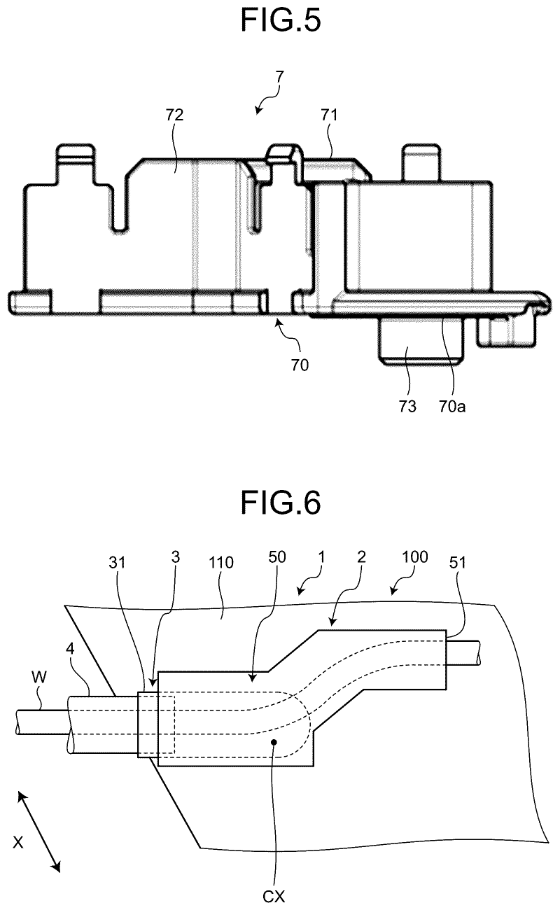

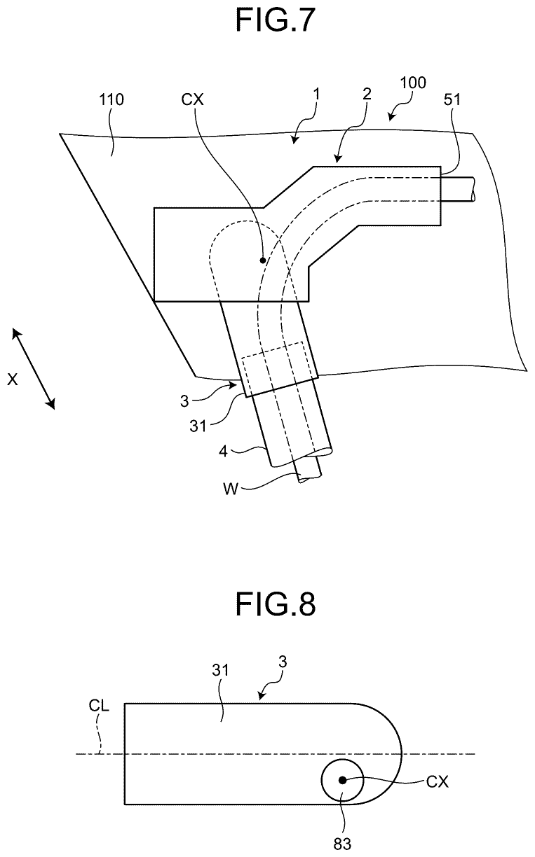

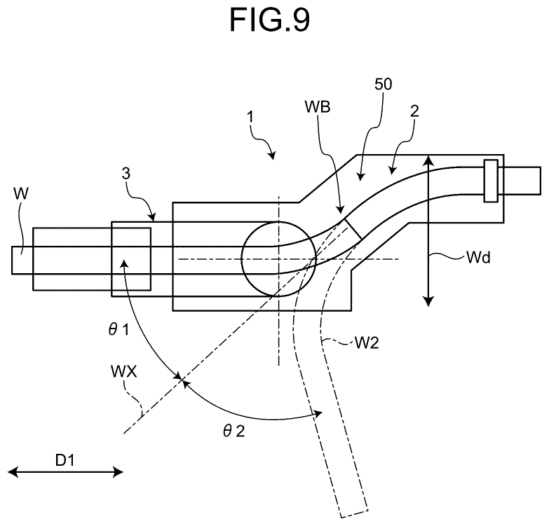

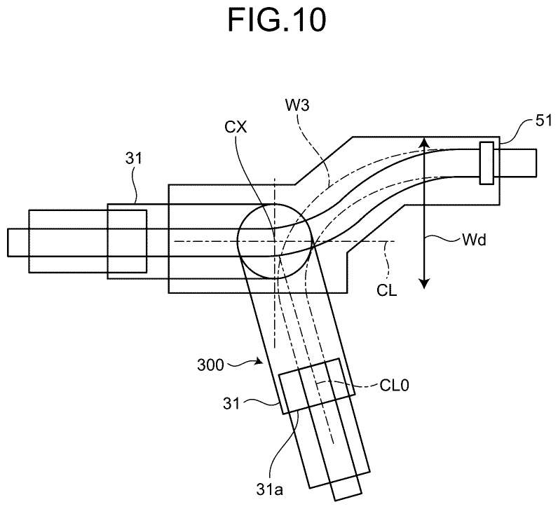

Referring to FIGS. 1 to 15, an embodiment will be described. The present embodiment relates to a routing structure. FIG. 1 is a plan view of a routing structure according to an embodiment, FIG. 2 is an exploded perspective view of a protector according to the embodiment, FIG. 3 is a rear view of an upper cover according to the embodiment, FIG. 4 is an exploded perspective view of a rotary member according to the embodiment, FIG. 5 is a side view of a first member according to the embodiment, FIGS. 6 and 7 are plan views of the routing structure according to the embodiment, FIG. 8 is an exploded perspective view of the rotary member according to the embodiment, FIG. 9 is a diagram illustrated to describe a routing route of an electric wire, and FIG. 10 is a diagram illustrating a rotary member according to a comparative example.

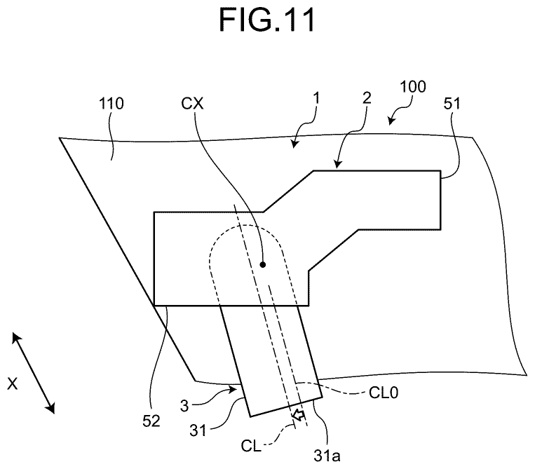

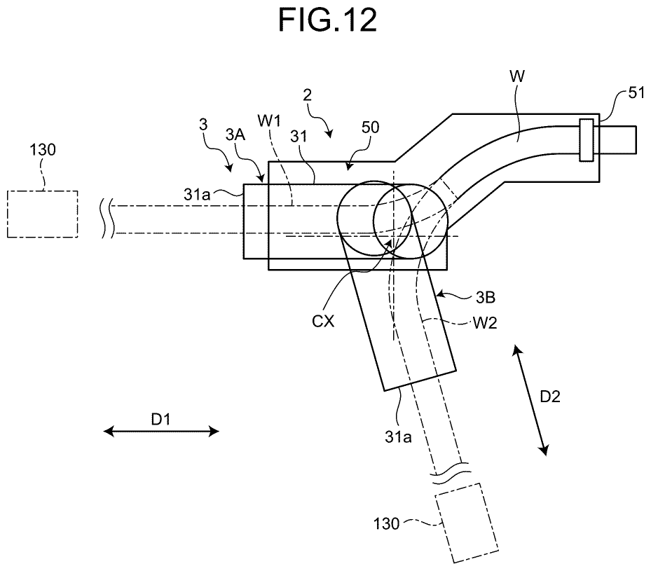

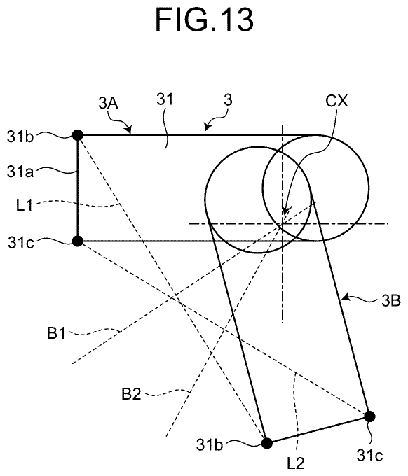

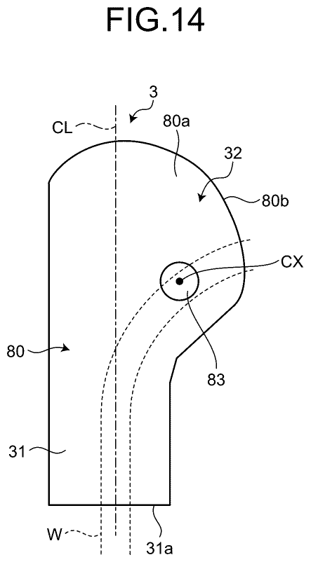

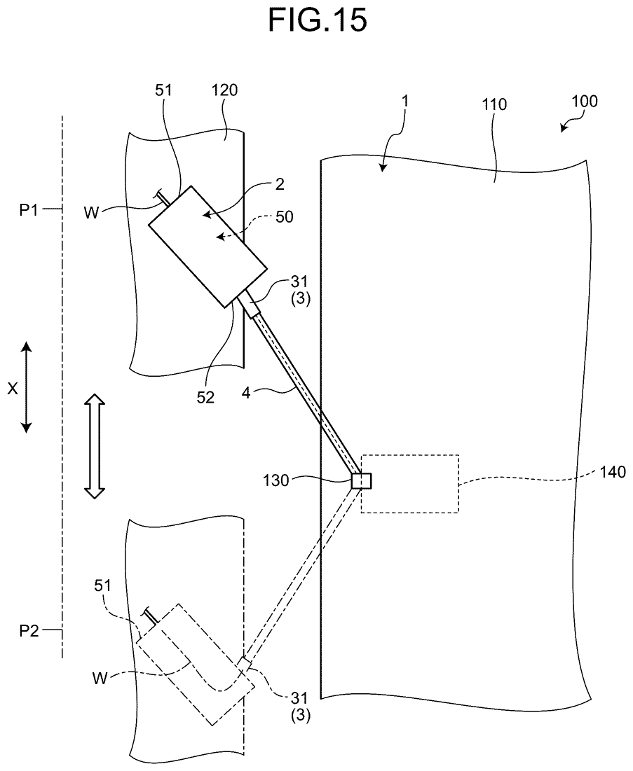

FIG. 11 is a plan view of the routing structure according to the embodiment, FIG. 12 is a diagram illustrating the routing route of the embodiment, FIG. 13 is a diagram illustrated to describe a shaft center of the embodiment, FIG. 14 is a diagram illustrating a shaft center arranged in a protrusion, and FIG. 15 is a plan view illustrating another example of the routing structure according to the embodiment.

As illustrated in FIG. 1, a routing structure 1 of the present embodiment is mounted on a vehicle 100 such as an automobile. The routing structure 1 includes a protector 2, a rotary member 3, an exterior member 4, and an electric wire W. The routing structure 1 couples a vehicle body 110 of the vehicle 100 with a sliding member 120. The sliding member 120 is, for example, a sliding door. The sliding member 120 moves relative to the vehicle body 110 along a first direction X. The first direction X is, for example, the front-rear direction of the vehicle 100. The sliding member 120 may slide due to the operation of a linkage mechanism that couples the vehicle body 110 with the sliding member 120. The sliding member 120 may slide while being guided by a rail arranged on the vehicle body 110.

The sliding member 120 moves between a first position P1 and a second position P2. The first position P1 is the first end point in the sliding range of the sliding member 120, and the second position P2 is the second end point in the sliding range of the sliding member 120. The first position P1 is, for example, a fully closed position of the sliding door. The second position P2 is, for example, a fully open position of the sliding door.

The protector 2 is arranged on the vehicle body 110 of the vehicle 100. The protector 2 is a cylindrical member having a routing path 50 along which the electric wire W is routed. The protector 2 is, for example, molded from an insulating synthetic resin.

The rotary member 3 is rotatably supported by the protector 2. The rotary member 3 has a cylindrical portion 31 through which the electric wire W is inserted, and it is arranged within the routing path 50 of the protector 2. The rotary member 3 rotates between a first rotational position and a second rotational position. The position of the rotary member 3 indicated by a solid line in FIG. 1 represents the first rotational position. The first rotational position is a rotational position in which the cylindrical portion 31 is directed toward the sliding member 120 located at the first position P1. The position of the rotary member 3 indicated by the dashed line in FIG. 1 is the second rotational position. The second rotational position is a rotational position in which the cylindrical portion 31 is directed toward the sliding member 120 located at the second position P2.

The exterior member 4 is a cylindrical protective member that encloses the electric wire W. The exterior member 4 is, for example, a bellows-shaped member known as a corrugated tube. The exterior member 4 has one end held by the rotary member 3. The exterior member 4 has the other end held by a holding member 130 provided on the sliding member 120.

In the routing structure 1, there is at least one electric wire W. The electric wire W is routed to the protector 2, the rotary member 3, the exterior member 4, and the holding member 130. The electric wire W is connected to a device arranged on the sliding member 120. The electric wire W may include, for example, a power supply line and a communication line.

The holding member 130 is arranged on the sliding member 120 and moves in the first direction X together with the sliding member 120. The holding member 130 is, for example, a pivotably supported rotor member. In this case, the holding member 130 is capable of causing the exterior member 4 to extend from the rotary member 3 to the holding member 130 in a substantially straight line.

As illustrated in FIG. 2, the protector 2 has a lower cover 5 and an upper cover 6. The lower cover 5 has the routing path 50 with a groove shape in which the electric wire W is routed. The upper cover 6 engages with the lower cover 5 to cover the routing path 50. The routing path 50 has a first opening 51 and a second opening 52. The first opening 51 is an opening through which the electric wire W is drawn out toward the vehicle body 110. The second opening 52 is an opening through which the electric wire W is drawn out toward the sliding member 120.

The lower cover 5 has a through-hole 53 that rotatably supports the rotary member 3. The through-hole 53 is arranged near the second opening 52 in the routing path 50. The through-hole 53 passes through the lower cover 5 along the engagement direction in which the lower cover 5 engages with the upper cover 6. As illustrated in FIG. 3, the upper cover 6 has a recess 61. The recess 61 faces the through-hole 53 of the lower cover 5. The upper cover 6 rotatably supports the rotary member 3 through the recess 61. As illustrated in FIG. 2, an engaging portion 54 is provided on the outer surface of the lower cover 5. The upper cover 6 has an engaging portion 62 that engages with the engaging portion 54. The lower cover 5 and the upper cover 6 have fixing portions 55 and 63, respectively, that are fixed to the vehicle body 110. The fixing portions 55 and 63 have through-holes for insertion of a fastening member such as a bolt.

As illustrated in FIG. 4, the rotary member 3 has a first member 7 and a second member 8. The first member 7 and the second member 8 are molded from, for example, an insulating synthetic resin. The first member 7 has an opposing wall 70, a first side wall 71, and a second side wall 72. The second member 8 has an opposing wall 80, a first side wall 81, and a second side wall 82. The first member 7 and the second member 8 engage with each other while aligning their opposing walls 70 and 80 to face each other.

As illustrated in FIG. 5, the first member 7 has a shaft portion 73. The shaft portion 73 is inserted into the through-hole 53 of the protector 2 and is rotatably supported by the through-hole 53. The shaft portion 73 protrudes from the opposing wall 70 toward the side opposite to the side walls 71 and 72. The shaft portion 73 is arranged at a first end 70a of the opposing wall 70 in the longitudinal direction. The first end 70a is an end portion from which the electric wire W is drawn out toward the first opening 51 of the protector 2.

As illustrated in FIG. 4, the side walls 71 and 72 of the first member 7 are erected from the edge of the opposing wall 70. The opposing wall 70, the first side wall 71, and the second side wall 72 form a passage having a rectangular cross-section. The first side wall 71 of the present embodiment extends linearly. The second side wall 72 has a curved end portion. More specifically, the second side wall 72 is curved away from the first side wall 71 as it approaches the first end 70a of the opposing wall 70. The width of the opposing wall 70 varies depending on the curved shape of the second side wall 72, becoming wider as it approaches the first end 70a. The first end 70a has an edge 70b of a substantially arcuate shape. The opposing wall 70 has a second end 70c equipped with a rib 74 that locks the end of the exterior member 4. The second end 70c is an end portion opposite to the opposing wall 70 from the first end 70a.

The second member 8 has a shaft portion 83. The shaft portion 83 is inserted into the recess 61 of the protector 2 and is rotatably supported by the recess 61. The shaft portion 83 protrudes from the opposing wall 80 toward the side opposite to the side walls 81 and 82. The shaft portion 83 is positioned at a first end 80a of the opposing wall 80 in the longitudinal direction. The first end 80a is an end portion opposite to the first end 70a of the first member 7.

The side walls 81 and 82 of the second member 8 are erected from the edge of the opposing wall 80. The opposing wall 80, the first side wall 81, and the second side wall 82 form a passage having a rectangular cross-section. The first side wall 81 extends linearly. The second side wall 82 has a curved end portion corresponding to the second side wall 72 of the first member 7. More specifically, the second side wall 82 is curved away from the first side wall 81 as it approaches the first end 80a of the opposing wall 80. Thus, the width of the opposing wall 80 becomes wider as it approaches the first end 80a. The first end 80a has an edge 80b with a substantially arcuate shape.

The first member 7 has an engaging portion 75. The second member 8 has an engaging portion 85 that engages with the engaging portion 75. By combining the first member 7 and the second member 8, a rectangular tube-shaped cylindrical portion 31 is formed. The electric wire W is drawn out toward the sliding member 120 from the second end 70c.

FIG. 6 illustrates the rotary member 3 in the first rotational position. The exterior member 4 and the electric wire W extend from the rotary member 3 toward the sliding member 120 at the first position P1. FIG. 7 illustrates the rotary member 3 in the second rotational position. The exterior member 4 and the electric wire W extend from the rotary member 3 toward the sliding member 120 at the second position P2. The rotary member 3 of the present embodiment is pivotally rotated about a shaft center CX. As described below, the position of the shaft center CX is determined in such a way as to form an appropriate bending radius R in the electric wire W.

FIG. 8 illustrates a standalone rotary member 3. The shaft center CX is the central shaft line of the shaft portion 83. The shaft portion 73 is arranged coaxially with the shaft portion 83. Thus, the shaft center CX is also the central shaft line of the shaft portion 73. The position of the shaft center CX is a position shifted from a central shaft line CL of the cylindrical portion 31. The position of the shaft center CX is set such that the length of the routing route of the electric wire W is to be equal in both the case where the rotary member 3 is at the first rotational position and in the case where the rotary member 3 is at the second rotational position.

In FIG. 9, a routing route W2 of the electric wire W in the case where the sliding member 120 is at the second position P2 is indicated by a dashed-dotted line. The bending radius R of the electric wire W inside the protector 2 varies depending on the direction in which the electric wire W is drawn out toward the sliding member 120. In the arrangement of the protector 2 of the present embodiment, the bending radius R of the electric wire W is set to be smaller in the case where the sliding member 120 is at the second position P2 than in the case where the sliding member 120 is at the first position P1. The routing route W2 is a route to be targeted and is set such that the bending radius R at a base point WB is equal to or greater than a predetermined value. In the case where the sliding member 120 moves, the bending direction of the electric wire W varies with reference to the base point WB.

FIG. 9 illustrates a shaft line direction WX of the base point WB. In this regard, in the case where a width Wd is shortened to minimize the size of the protector 2, the deflection angle of the electric wire W relative to the shaft line direction WX tends to become uneven. More specifically, in the case where the sliding member 120 is at the first position P1, the deflection angle of the electric wire W relative to the shaft line direction WX is a first angle θ1. In the case where the sliding member 120 is at the second position P2, the deflection angle of the electric wire W relative to the shaft line direction WX is a second angle θ2. In the case of shortening the width Wd, the second angle θ2 becomes larger than the first angle θ1.

As described above, in the case where the deflection angle of the electric wire W becomes uneven, it is necessary to control the bending radius R of the electric wire W to prevent it from becoming too small in the case where the sliding member 120 is at the second position P2. FIG. 10 illustrates a rotary member 300 according to a comparative example. In the rotary member 300 of the comparative example, the shaft center CX is arranged on the central shaft line CL of the cylindrical portion 31. In a routing route W3 of the electric wire W formed by the rotary member 300 of the comparative example, the bending radius R of the electric wire W is small. This is because the path length from the first opening 51 to a tip 31a of the cylindrical portion 31 is shortened due to reducing the width Wd.

As illustrated in FIG. 11, in the routing structure 1 of the present embodiment, in the case where the rotary member 3 is at the second rotational position, the shaft center CX is positioned on the side of the first opening 51 with respect to the central shaft line CL of the cylindrical portion 31. In other words, the shaft center CX is located at an eccentric position with respect to the central shaft line CL of the cylindrical portion 31. As illustrated in FIG. 11, a comparison line CLO is the central shaft line of the cylindrical portion 31 in the case where the rotary member 300 of the comparative example illustrated in FIG. 10 is at the second rotational position. In other words, the comparison line CLO is the central shaft line of the cylindrical portion 31 in the case where the shaft center CX is set on the central shaft line CL.

As illustrated in FIG. 11, in the case where the rotary member 3 is at the second rotational position, the central shaft line CL of the present embodiment is located further away from the first opening 51 with respect to the comparison line CLO. Thus, the routing structure 1 of the present embodiment makes it possible to increase the bending radius R of the electric wire W inside the protector 2.

The position of the shaft center CX is preferably set so that, for example, the path length of the electric wire W at the first rotational position is equal to the path length of the electric wire W at the second rotational position. Herein, the two path lengths are path lengths from the first opening 51 of the protector 2 to the tip 31a of the cylindrical portion 31. The path length at the second rotational position is set in such a way that the bending radius R of the electric wire W inside the protector 2 is equal to or greater than a predetermined value.

An example of a method of determining the position of the shaft center CX is now described. FIG. 12 illustrates two designed routing routes W1 and W2. The routing route W1 is the routing route for the electric wire W in the case where the sliding member 120 is at the first position P1. The routing route W1 is determined on the basis of the relative position of the holding member 130 with respect to the protector 2, the shape of the routing path 50, and the like. In the present embodiment, in the case where the sliding member 120 is at the first position P1, the holding member 130 is located in an extending direction D1 of the routing path 50 with respect to the protector 2. Thus, the electric wire W extends from the protector 2 along the extending direction D1. Consequently, the routing route W1 is gently curved in the routing path 50.

In the case where the sliding member 120 is at the second position P2, the holding member 130 is located in a direction D2 that intersects with the extending direction D1 with respect to the protector 2. Thus, the electric wire W extends from the protector 2 along the direction D2. The direction D2 in the present embodiment intersects with the extending direction D1 at an angle close to a right angle. Thus, the routing route W2 is curved in such a way as to cause the direction of the electric wire W to be significantly changed in the routing path 50. The routing route W2 is set so that the bending radius R formed in the electric wire W is equal to or greater than a predetermined value R1.

Based on the routing routes W1 and W2, a target position of the rotary member 3 is set. In FIG. 12, two positions 3A and 3B of the rotary member 3 are illustrated. The position 3A is the target position of the rotary member 3 in the case where the sliding member 120 is at the first position P1. In other words, the position 3A is a position where the electric wire W is extended along the routing route W1. The position 3A is determined, for example, so that the center line of the routing route W1 and the central shaft line CL of the cylindrical portion 31 are aligned.

The position 3B is the target position of the rotary member 3 in the case where the sliding member 120 is at the second position P2. In other words, the position 3B is a position where the electric wire W is extended along the routing route W2. The position 3B is determined, for example, so that the center line of the routing route W2 and the central shaft line CL of the cylindrical portion 31 are aligned. The two positions 3A and 3B are set so that the length of the electric wire from the first opening 51 to the tip 31a of the cylindrical portion 31 is equal. The position of the shaft center CX is set so that the two positions 3A and 3B are compatible, as described below.

As illustrated in FIG. 13, the cylindrical portion 31 has two angular portions 31b and 31c. FIG. 13 illustrates a line segment L1 connecting the angular portion 31b at the position 3A and the angular portion 31b at the position 3B and illustrates a perpendicular bisector B1 of the line segment L1. Furthermore, illustrated are a line segment L2 connecting the angular portion 31c at the position 3A and the angular portion 31c at the position 3B and a perpendicular bisector B2 of line segment L2. The shaft center CX is set at the intersection of two perpendicular bisectors B1 and B2. This arrangement causes the rotary member 3 to be positioned at the two positions 3A and 3B to be targeted.

Moreover, as illustrated in FIG. 14, in the case where the rotary member 3 has a protrusion 32, the shaft center CX may be arranged on the protrusion 32. The rotary member 3 illustrated in FIG. 14 has the protrusion 32 that protrudes from the cylindrical portion 31. The protrusion 32 protrudes from the cylindrical portion 31 in a direction away from the central shaft line CL. Arranging the shaft center CX on the protrusion 32 makes the distance from the central shaft line CL to the shaft center CX larger.

As described above, the routing structure 1 of the present embodiment includes the protector 2 and the rotary member 3. The protector 2 is arranged on the vehicle body 110 of the vehicle 100 and has the routing path 50. The electric wire W connecting the vehicle body 110 and the sliding member 120 is routed in the routing path 50. The rotary member 3 is arranged in the routing path 50. The rotary member 3 has the cylindrical portion 31 through which the electric wire W is inserted and is rotatably supported by the protector 2. The routing path 50 has the first opening 51 through which the electric wire W is drawn out toward the vehicle body 110 and the second opening 52 through which the electric wire W is drawn out toward the sliding member 120 as the counterpart.

The rotary member 3 rotates between a first rotational position and a second rotational position. The first rotational position is a rotational position in which the cylindrical portion 31 is directed toward the sliding member 120 in the case where the sliding member 120 as the counterpart is at the first position P1 in the sliding direction. The second rotational position is a rotational position in which the cylindrical portion 31 is directed toward the sliding member 120 in the case where the sliding member 120 as the counterpart is at the second position P2 in the sliding direction. The electric wire W is curved between the first opening 51 and the rotary member 3 in the case where the rotary member 3 is at the second rotational position. The shaft center CX of the rotating shaft that pivotally rotates the rotary member 3 is located on the side of the first opening 51 with respect to the central shaft line CL of the cylindrical portion 31 in the case where the rotary member 3 is at the second rotational position. According to the routing structure 1 of the present embodiment, the bending radius R of the electric wire W inside the protector 2 can be adjusted to prevent it from being too small.

The rotary member 3 may have the protrusion 32 that protrudes from the cylindrical portion 31 in a direction away from the central shaft line CL. In this case, the shaft center CX may be arranged on the protrusion 32. The protrusion 32 may be provided to include the intersection of the two perpendicular bisectors B1 and B2 in FIG. 13. In other words, the protrusion 32 may be provided depending on the position of the shaft center CX to be targeted.

Moreover, the protector 2 and the rotary member 3 may be arranged on the sliding member 120. FIG. 15 illustrates the routing structure 1 having the protector 2 and the rotary member 3 arranged on the sliding member 120. The protector 2 is arranged on the sliding member 120 and fixed to the sliding member 120. In this case, the electric wire W is drawn out from the first opening 51 of the routing path 50 toward the sliding member 120. Further, the electric wire W is drawn out from the second opening 52 toward the vehicle body 110 as the counterpart.

The holding member 130 is arranged on the vehicle body 110 and holds the end of the exterior member 4. The holding member 130 is, for example, a pivotably supported rotor member. On the vehicle body 110, a vehicle body-side protector 140 that rotatably supports the holding member 130 may be placed. In this case, the electric wire W is drawn out from the vehicle body-side protector 140 toward a power source or the like.

The rotary member 3 is arranged in the routing path 50 of the protector 2 and is rotatably supported by the protector 2. The rotary member 3 rotates in such a way as to cause the exterior member 4 to be extended toward the holding member 130.

In FIG. 15, the position of the rotary member 3 indicated by the solid line is the first rotational position. The first rotational position is a rotational position in which the cylindrical portion 31 is directed toward the vehicle body 110 as the counterpart in the case where the sliding member 120 is at the first position P1 in the sliding direction. More specifically, the rotary member 3 in the first rotational position causes the cylindrical portion 31 to face the holding member 130.

The position of the rotary member 3 indicated by the dashed line is the second rotational position. The second rotational position is a rotational position in which the cylindrical portion 31 is directed toward the vehicle body 110 as the counterpart in the case where the sliding member 120 is at the second position P2 in the sliding direction. More specifically, the rotary member 3 in the second rotational position causes the cylindrical portion 31 to face the holding member 130.

The electric wire W is curved between the first opening 51 and the rotary member 3 in the case where the rotary member 3 is at the second rotational position. As described with reference to FIG. 11, the shaft center CX of the rotating shaft for pivotally rotating the rotary member 3 is located on the side of the first opening 51 with respect to the central shaft line CL of the cylindrical portion 31 in the case where the rotary member 3 is at the second rotational position. The routing structure 1 of the present embodiment can be adjusted to prevent the bending radius R of the electric wire W inside the protector 2 from being too small even in the case where the protector 2 and the rotary member 3 are arranged on the sliding member 120.

Moreover, the shape and arrangement of the protector 2 are not limited to the illustrated shape and arrangement. Further, the shape and arrangement of the rotary member 3 are not limited to the illustrated shape and arrangement. The sliding member 120 is not limited to a sliding door. The sliding member 120 may be other members that are slidable with respect to the vehicle body 110.

The shaft portions 73 and 83 that rotatably support the rotary member 3 may be provided in the protector 2. In this case, the rotary member 3 may be provided with a recess or a through-hole into which the shaft portions 73 and 83 are inserted.

The details disclosed in the above embodiments can be executed in appropriate combinations.

In the routing structure according to an embodiment of the present invention, the shaft center of the rotating shaft that pivotally rotates the rotary member is located on the side of the first opening with respect to the central shaft line of the cylindrical portion, which is the case when the rotary member is at the second rotational position. According to the routing structure according to an embodiment of the present invention, making the distance between the central shaft line of the cylindrical portion and the first opening at the second rotational position larger enables achievement of the effects of reducing the degree of curvature of the electric wire.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A routing structure comprising:
a protector arranged on either a vehicle body of a vehicle or a sliding member, and having a routing path in which an electric wire used to connect the vehicle body and the sliding member is routed; and
a rotary member arranged in the routing path, having a cylindrical portion through which the electric wire is inserted, and rotatably supported by the protector, wherein
the routing path has a first opening through which the electric wire is drawn out toward one of the vehicle body and the sliding member, and a second opening through which the electric wire is drawn out toward a counterpart as the other of the vehicle body and the sliding member,
the rotary member is pivotally rotated between a first rotational position and a second rotational position,
the first rotational position is a rotational position in which the cylindrical portion is directed toward the counterpart in a case where the sliding member is at a first position in a sliding direction,
the second rotational position is a rotational position in which the cylindrical portion is directed toward the counterpart in a case where the sliding member is at a second position in the sliding direction,
the electric wire is curved between the first opening and the rotary member in a case where the rotary member is at the second rotational position, and
the rotary member is pivotally rotated about a shaft center of a rotating shaft, and the shaft center is located on a side of the first opening with respect to a central shaft line of the cylindrical portion in the case where the rotary member is at the second rotational position.

2. The routing structure according to claim 1, wherein
the rotary member has a protrusion protruding in a direction away from the central shaft line with respect to the cylindrical portion, and
the shaft center is arranged on the protrusion.
